(19) United States
(12) Patent Application Publication
(10) Pub. No.: US 2022/0396712 A1
(43) Pub. Date: Dec. 15, 2022

(54) WATER-BASED OIL RESISTANT AGENT AND OIL RESISTANT PAPER

(71) Applicant: ARAKAWA CHEMICAL INDUSTRIES, LTD., OSAKA (JP)

(72) Inventors: Keisuke Okada, Osaka (JP); Takashi Minabe, Osaka (JP); Kosuke Tsuji, Osaka (JP)

(73) Assignee: ARAKAWA CHEMICAL INDUSTRIES, LTD., OSAKA (JP)

(21) Appl. No.: 17/833,900

(22) Filed: Jun. 7, 2022

(30) Foreign Application Priority Data
Jun. 9, 2021 (JP) 2021-096286

(51) Int. Cl. C09D 175/12; D21H 21/14; C09D 7/65; C09D 7/63; C09D 7/61

(52) U.S. Cl. CPC C09D 175/12; D21H 21/14; C09D 7/65; C09D 7/63; C09D 7/61

(57) ABSTRACT

A water-based oil resistant agent containing at least one resin (A) selected from the group consisting of the following (A1) and (A2), and a paraffin wax (B):
(A1) an olefin resin which is a polymer containing monoolefins having a total number of carbon atoms of 4 or more (a1-1) and an α,β-unsaturated carboxylic acid (a1-2) as essential reaction components; and
(A2) a urethane resin which is a polymer containing a polyol (a2-1), a polyisocyanate (a2-2) and a chain extender (a2-3) as essential reaction components.

### CROSS-REFERENCE TO RELATED APPLICATION

This application claims the priority benefit of Japan Application No. 2021-096286, filed on Jun. 9, 2021. The entirety of the above-mentioned patent application is hereby incorporated by reference herein and made a part of this specification.

### BACKGROUND

### Technical Field

The disclosure relates to a water-based oil resistant agent and oil resistant paper.

### Description of Related Art

Oil resistant paper is widely used as wrapping paper for cooked foodstuffs containing large amounts of oil and water such as fried chicken, hamburgers, and grilled fish, and foodstuffs containing large amounts of oils and fats such as chocolate; paper coverings such as packaging containers and food trays, wrapping paper for drying agents and oxygen scavengers, pet food bags, and heavy bags for flour milling; building material paper, and the like. In addition, chemicals that impart oil resistance to paper are called oil resistant agents.

In the related art, fluorine resin agents have been used as oil resistant agents, and for example, a method in which a fluorine resin-based oil resistant agent is applied to a surface of a paper substrate or impregnated into a paper substrate or added to a pulp slurry is used. However, oil resistant paper obtained using an oil resistant agent may generate perfluoro compounds when heated, which is not preferable in consideration of an environmental load, and in recent years, there has come to be demand for an oil resistant agent containing no fluorine resin (non-fluorine-resin-based oil resistant agent).

As a technique for such an oil resistant agent, for example, oil resistant paper having a layer of an oil resistant agent in which starch having a hydrophobic group and wax are mixed is known (Patent Document 1). However, in the case of a non-fluorine-based oil resistant agent, the amount of the oil resistant agent increases because oil resistance is exhibited while oil and fat components are prevented from exuding. Accordingly, the oil resistance is improved, but the air permeability is insufficient (the air impermeability increases), which tends to cause deterioration of food flavor and storage stability. Although the air permeability is improved in Patent Document 1, there is room for further improvement.

### PATENT DOCUMENTS

[Patent Document 1] Japanese Patent Laid-Open No. 2013-237941

The disclosure provides a water-based oil resistant agent that allows oil resistant paper having excellent oil resistance and air permeability to be provided.

The inventors conducted extensive studies and found that a water-based oil resistant agent containing a specific resin and a paraffin wax can address the above problem and completed the disclosure. That is, the disclosure relates to the following water-based oil resistant agent and oil resistant paper.

### SUMMARY

1. A water-based oil resistant agent containing at least one resin (A) selected from the group consisting of the following (A1) and (A2), and a paraffin wax (B):

(A1) an olefin resin which is a polymer containing monoolefins having a total number of carbon atoms of 4 or more (a1-1) and an α,β-unsaturated carboxylic acid (a1-2) as essential reaction components; and

(A2) a urethane resin which is a polymer containing a polyol (a2-1), a polyisocyanate (a2-2) and a chain extender (a2-3) as essential reaction components.

2. The water-based oil resistant agent according to 1, wherein the components (a1-1) are a monoolefin having a total number of carbon atoms of 4 to 10 (I) and a monoolefin having a total number of carbon atoms of 12 to 20 (II).

3. The water-based oil resistant agent according to 1 or 2, wherein the reaction components constituting the resin (A1) further contain an α,β-unsaturated monocarboxylic acid alkyl ester (a1-3).

4. The water-based oil resistant agent according to any one of 1 to 3, wherein the component (a2-3) contains a dialkanol alkanoic acid.

5. The water-based oil resistant agent according to any one of 1 to 4, wherein a content ratio between the component (A) and the component (B) in terms of the non-volatile content weight is (A)/(B)=10/90 to 90/10.

6. Oil resistant paper obtained by applying the water-based oil resistant agent according to any one of 1 to 5 to base paper.

### DESCRIPTION OF THE EMBODIMENTS

According to the water-based oil resistant agent of the disclosure, oil resistant paper having excellent oil resistance and air permeability is provided.

A water-based oil resistant agent of the disclosure contains at least one resin (A) selected from the group consisting of a specific olefin resin (A1) and a urethane resin (A2), and a paraffin wax (B).

First, the olefin resin (A1) (hereinafter referred to as a resin (A1)) will be described.

The resin (A1) is a polymer containing monoolefins having a total number of carbon atoms of 4 or more (a1-1) (hereinafter referred to as a component (a1-1)) and an α,β-unsaturated carboxylic acid (a1-2) (hereinafter referred to as a component (a1-2)) as essential reaction components, and is a component that imparts excellent oil resistance to a water-based oil resistant agent.

The components (a1-1) are monoolefins having a total number of carbon atoms of 4 or more.

Examples of components (a1-1) include linear olefins such as 1-butene, 2-butene, 1-pentene, 2-pentene, 1-hexene, 2-hexene, 3-hexene, 1-heptene, 2-heptene, 3-heptene, 1-octene, 2-octene, 3-octene, 4-octene, isooctene, 1-decene, 2-decene, 3-decene, 4-decene, 1-dodecene, 2-dodecene, 3-dodecene, 1-tetradecene, 2-tetradecene, 3-tetradecene, 1-hexadecene, 2-hexadecene, 3-hexadecene, 1-octadecene, 2-octadecene, 3-octadecene, 1-eicosene, 1-tetracosene, and 1-triacontene; mixtures of 2-methylpropene (isobutene), 2,4,4-trimethyl-1-pentene, 2,4,4-trimethyl-2-pentene, 2,4,4-trimethyl-1-pentene, and 2,4,4-trimethyl-2-pentene (these are called diisobutylene), branched olefins such as 2-methyl-1-butene, 3-methyl-1-butene (isopentene), 2-methyl-1-pentene, 2-ethyl-1-butene, 3-methyl-1-pentene, 4-methyl-1-pentene (isohexene), 2-ethyl-1-pentene, 3-ethyl-1-pentene, 2-methyl-3-ethyl-1-pentene, 2-methyl-1-hexene, 3-methyl-1-hexene, 4-methyl-1-hexene, 2-ethyl-1-hexene, 3-ethyl-1-hexene, 2-methyl-1-octene, and 3-methyl-1-octene; and cyclic olefins such as cyclohexene, methylcyclohexene, vinylcyclohexane, 4-vinylcyclohexene, cyclopentene, and methylcyclopentene. These may be used alone or two or more thereof may be used in combination. In addition, isomers (cis form and trans form) of these olefins can also be used without particular limitation. Among these, a monoolefin having a total number of carbon atoms of 4 to 20 is preferable, and in order for an oil resistant agent with a hydrophilic/hydrophobic balance to be water soluble and exhibit excellent oil resistance, it is more preferable to combine a monoolefin having a total number of carbon atoms of 4 to 10 and a monoolefin having a total number of carbon atoms of 12 to 20, and it is still more preferable to combine a monoolefin having a total number of carbon atoms of 6 to 8 and a monoolefin having a total number of carbon atoms of 15 to 20.

The amount of the component (a1-1) used with respect to 100 weight % of all reaction components constituting the resin (A1) is usually 20 to 70 weight % and preferably 30 to 60 weight % in terms of the non-volatile content weight (the same applies below).

The component (a1-2) is an α,β-unsaturated carboxylic acid.

Examples of components (a1-2) include α,β-unsaturated dicarboxylic acids such as maleic acid, itaconic acid, fumaric acid, muconic acid, and citraconic acid; α,β-unsaturated monocarboxylic acids such as acrylic acid, methacrylic acid, and crotonic acid; and acid anhydrides of unsaturated dicarboxylic acids, acid anhydrides of unsaturated monocarboxylic acids, monoalkyl esters of unsaturated dicarboxylic acids, and monoalkylamides of unsaturated dicarboxylic acids.

Examples of alkyl groups of the monoalkyl esters and the monoalkylamides include a methyl group, ethyl group, n-propyl group, isopropyl group, n-butyl group, isobutyl group, s-butyl group, t-butyl group, n-pentyl group, isopentyl group, n-hexyl group, cyclohexyl group, n-octyl group, (2-ethylhexyl) group, n-decyl group, n-dodecyl group, n-tetradecyl group, n-hexadecyl group, n-octadecyl group, n-nonadecyl group, n-eicosyl group, and n-docosyl group.

These components (a1-2) may be used alone or two or more thereof may be used in combination. Among these, maleic acid, fumaric acid, itaconic acid, maleic anhydride, and (meth)acrylic acid are preferable because the obtained polymer produced during the reaction is easily dissolved or dispersed in water.

Regarding the component (a1-2), a neutralized salt of these α,β-unsaturated carboxylic acids may be used. Examples of neutralized salts include alkali metal salts such as sodium salts and potassium salts; and ammonium salts.

When the neutralized salt is prepared, for example, alkali metal hydroxides such as sodium hydroxide and potassium hydroxide; inorganic amines such as ammonia and ammonium carbonate; alkylamines such as methylamine, dimethylamine, trimethylamine, ethylamine, diethylamine, triethylamine, and n-butylamine; and cycloalkylamines such as cyclohexylamine; and aromatic amines such as aniline can be used. These may be used alone or two or more thereof may be used in combination.

The amount of the component (a1-2) used with respect to 100 weight % of all reaction components constituting the resin (A1) is usually 10 to 50 weight % and preferably 20 to 40 weight %.

The reaction components constituting the resin (A1) may further contain an α,β-unsaturated monocarboxylic acid alkyl ester (a1-3) (hereinafter referred to as a component (a1-3)).

Examples of α,β-unsaturated monocarboxylic acids include those mentioned in the previous paragraph. These may be used alone or two or more thereof may be used in combination. Examples of alkyl groups include a methyl group, ethyl group, n-propyl group, isopropyl group, n-butyl group, isobutyl group, s-butyl group, t-butyl group, n-pentyl group, isopentyl group, neopentyl group, cyclopentyl group, n-hexyl group, isohexyl group, cyclohexyl group, n-heptyl group, isoheptyl group, n-octyl group, isooctyl group, n-nonyl group, isononyl group, n-decyl group, isodecyl group, n-undecyl group, n-dodecyl group, n-tricdecyl group, n-tetradecyl group, n-pentadecyl group, n-hexadecyl group, n-heptadecyl group, n-octadecyl group, n-nonadecyl group, n-eicosyl group, and n-docosyl group. These may be used alone or two or more thereof may be used in combination.

The amount of the component (a1-3) used with respect to 100 weight % of all reaction components constituting the resin (A1) is usually 20 weight % or less and preferably 1 to 10 weight %.

The reaction components constituting the resin (A1) may contain a polymerizable monomer (a1-4) (hereinafter referred to as a component (a1-4)) other than the components (a1-1) to (a1-3).

Examples of components (a1-4) include styrenes such as styrene, α-methylstyrene, t-butylstyrene, dimethylstyrene, acetoxystyrene, hydroxystyrene, vinyltoluene, and chlorovinyltoluene;

(meth)acrylic acid esters having a hydroxy group such as 2-hydroxymethyl (meth)acrylate, 2-hydroxyethyl (meth)acrylate, 2-hydroxybutyl (meth)acrylate, glycerin mono(meth)acrylate, glycerin di(meth)acrylate, pentaerythritol mono(meth)acrylate, and pentaerythritol di(meth)acrylate;
aminoalkyl (meth)acrylates such as aminoethyl (meth)acrylate, aminopropyl (meth)acrylate, aminobutyl (meth)acrylate, N-methylaminoethyl (meth)acrylate, N-methylaminopropyl (meth)acrylate, N-methylaminobutyl (meth)acrylate, N,N-dimethylaminoethyl (meth)acrylate, N,N-dimethylaminopropyl (meth)acrylate, N,N-dimethylaminobutyl (meth)acrylate, N,N-diethylaminoethyl (meth)acrylate, N,N-diethylaminopropyl (meth)acrylate, and N,N-diethylaminobutyl (meth)acrylate;
monomers having a sulfo group such as styrene sulfonic acid, α-methylstyrene sulfonic acid, vinyl sulfonic acid, 2-(meth)acrylamide-2-methylpropane sulfonic acid, (meth)allylamide-N-methylsulfonic acid, (meth)acrylamide phenylpropane sulfonic acid, (meth)allyl sulfonic acid, sulfoethyl (meth)acrylate, sulfopropyl (meth)acrylate, and sulfo 2-hydroxypropyl (meth)acrylate;
divinyl esters such as divinyl adipate and divinyl sebacate;
polyethylene glycol mono(meth)acrylates such as diethylene glycol mono(meth)acrylate, triethylene glycol mono(meth)acrylate, and tetraethylene glycol mono(meth)acrylate; polyethylene glycol di(meth)acrylates such as ethylene glycol di(meth)acrylate, and diethylene glycol di(meth)acrylate;
polyalkylene glycol mono(meth)acrylates such as polypropylene glycol mono(meth)acrylate, methoxypolyethylene glycol mono(meth)acrylate, polytrimethylene glycol mono(meth)acrylate, polytetramethylene glycol mono(meth)acrylate, and polyethylene glycol propylene glycol mono(meth)acrylate;
(meth)acrylamides such as (meth)acrylamide, N-methylol (meth)acrylamide, N-ethyl (meth)acrylamide, N-isopropylacrylamide, N-butyl (meth)acrylamide, N-octyl (meth)acrylamide, N-methoxymethyl (meth)acrylamide, N-ethoxymethyl (meth)acrylamide, N-propoxymethyl (meth)acrylamide, N-butoxymethyl (meth)acrylamide, N-2-hydroxyethyl (meth)acrylamide, N,N-dihydroxyethyl (meth)acrylamide, N-(1,1-dimethyl-3-oxobutyl)acrylamide, N-allyl (meth)acrylamide, (meth)acrylamide glycolic acid, 2-acrylamide-2-methylpropane sulfonic acid, N,N-dimethyl (meth)acrylamide, N,N-diethyl (meth)acrylamide, N,N-diallyl (meth)acrylamide, N,N′-methylenebis (meth)acrylamide, and N,N′-ethylene bis(meth)acrylamide;
aromatic polyvinyls such as divinylbenzene, 1,3,5-triacryloylhexahydro-1,3,5-triazine, triallyl isocyanurate, triallyl trimellitate, triallylamine, tetramethylolmethane tetraacrylate, and tetraallyl pyromellitate; and
acrylonitrile. These may be used alone or two or more thereof may be used in combination.

The amount of the component (a1-4) used with respect to 100 weight % of all reaction components constituting the resin (A1) is usually 10 weight % or less and preferably 5 weight % or less.

The resin (A1) is prepared by adding the component (a1-1) and the component (a1-2), and as necessary, the component (a1-3) and the component (a1-4), adding a solvent, and causing a reaction in the presence of a polymerization initiator.

Examples of solvents include aromatic hydrocarbons such as benzene, toluene, ethylbenzene, n-propylbenzene, t-butylbenzene, o-xylene, m-xylene, p-xylene, tetralin, decalin, and aromatic naphtha; esters such as ethyl acetate, n-butyl acetate, n-amyl acetate, 2-hydroxyethyl acetate, 2-butoxyethyl acetate, 3-methoxybutyl acetate, and methyl benzoate; ketones such as acetone, methyl ethyl ketone, methyl isobutyl ketone, isophorone, cyclohexanone, and methylcyclohexanone; alcohols such as methanol, ethanol, n-propanol, isopropanol, n-butanol, isobutanol, s-butanol, and t-butanol; amides such as N,N-dimethylformamide and N,N-dimethylacetamide; and water such as deionized water, purified water, tap water, soft water, hard water, and industrial water. These may be used alone or two or more thereof may be used in combination. In addition, these solvents may be added during the reaction. In addition, when a solvent other than water is used, it is preferable to finally distill off the solvent from the reaction system by vacuum distillation or the like.

The amount of the solvent used is preferably adjusted so that the reaction concentration is 10 to 80 weight %.

Examples of polymerization initiators include persulfates such as ammonium persulfate, potassium persulfate, and sodium persulfate; azo compounds such as 2,2′-azobis(2-amidinopropane)hydrochloride, 2,2′-azobis[2(2-imidazolin-2-yl)propane]hydrochloride, 2,2′-azobisisobutyronitrile, and dimethyl-2,2′-azobisisobutyrate; organic peroxides such as benzoyl peroxide, dicumyl peroxide, and lauryl peroxide; and hydrogen peroxide. These may be used alone or two or more thereof may be used in combination. In addition, in combination with the polymerization initiator, for example, a reducing agent such as sodium sulfite and sodium thiosulfate may be used, and a reaction system may be redox.

The amount of the polymerization initiator used with respect to 100 parts by weight of all reaction components constituting the resin (A1) is usually about 0.01 to 5 parts by weight and preferably about 0.05 to 3 parts by weight.

In the reaction conditions, for example, the reaction temperature is usually 40 to 150° C., and preferably 60 to 120° C. In addition, the reaction time is usually 1 to 10 hours and preferably 1 to 3 hours.

In the reaction, a chain transfer agent may be additionally added. Examples of chain transfer agents include alkyl mercaptans such as n-octyl mercaptan, n-dodecyl mercaptan, t-dodecyl mercaptan, n-hexadecyl mercaptan, and n-octadecyl mercaptan; and 2-mercaptobenzothiazole, bromotrichloromethane, and α-methylstyrene dimer. These may be used alone or two or more thereof may be used in combination.

The amount of the chain transfer agent used with respect to 100 parts by weight of all reaction components constituting the resin (A1) is usually 5 parts by weight or less and preferably 3 parts by weight or less.

In the above reaction, before the reaction or during the reaction, a component (B) to be described below may be added.

In the above reaction, as necessary, inorganic acids such as sulfuric acid and phosphoric acid; alkali metal hydroxides such as sodium hydroxide and potassium hydroxide; inorganic amines such as ammonia and ammonium carbonate; alkylamines such as methylamine, dimethylamine, trimethylamine, ethylamine, diethylamine, triethylamine, and n-butylamine; cycloalkylamines such as cyclohexylamine; and aromatic amines such as aniline may be added before the reaction, during the reaction, and after the reaction. In addition, the reaction system is preferably in a nitrogen atmosphere.

The obtained component (A1) may contain additives such as a pigment, a water retention agent, an antifoaming agent, a preservative, a leveling agent, a colorant, an anti-blocking agent, an antioxidant, a UV absorber, a thickener, a dispersant, and a filler.

Regarding the physical properties of the obtained resin (A1), for example, the weight-average molecular weight is usually about 1,000 to 500,000 and preferably 5,000 to 50,000. Here, “weight-average molecular weight” is a value measured by a gel permeation chromatography (GPC) method using polystyrene as a standard substance.

In addition, the viscosity of the solution of the resin (A1) having a non-volatile content concentration of 20 weight % at a temperature of 25° C. is usually 5 to 50,000 mPa·s and preferably 10 to 10,000 mPa·s. Here, “viscosity” is a value measured by a B-type viscometer.

In addition, the pH of the resin (A1) is usually 5 to 11 and preferably 6 to 10. Here, “pH” is a value measured by a commercially available pH measuring machine.

Next, the urethane resin (A2) (hereinafter referred to as a resin (A2)) will be described.

The resin (A2) is a polymer containing a polyol (a2-1) (hereinafter referred to as a component (a2-1)), a polyisocyanate (a2-2) (hereinafter referred to as a component (a2-2)) and a chain extender (a2-3) (hereinafter referred to as a component (a2-3)) as essential reaction components, and is a component that imparts excellent oil resistance to a water-based oil resistant agent.

The component (a2-1) is a compound having two or more hydroxy groups in the molecule, and examples thereof include polyether polyol, poly (meth)acrylic polyol, polycaprolactone polyol, and polycarbonate polyol. These may be used alone or two or more thereof may be used in combination. Among these, polyether polyol is preferable.

Examples of polyether polyols include polyethylene glycol, polypropylene glycol, polybutylene glycol, polytetramethylene glycol, polyhexamethylene glycol, polyheptamethylene glycol, polydecamethylene glycol, polyoxyethylene-polyoxypropylene glycol, polyoxytetramethylene-polyoxyethylene glycol, and polyoxytetramethylene-polyoxypropylene glycol. Here, a polyether polyol having a random structure or a block structure can be used.

Examples of commercially available products of polyether polyols include “Adeka Polyether P-400,” “Adeka Polyether G-400,” “Adeka Polyether T-400,” “Adeka Polyether AM-302,” “Adeka Polyether P1000,” and “Adeka Polyether P2000” (all are commercially available from ADEKA); “Polyethylene glycol #1,540” (commercially available from Nacalai Tesque, Inc.); “Dipropylene glycol,” and “Polypropylene glycol 400” (all are commercially available from Junsei Chemical Co., Ltd.); “PEG #200,” “PEG #300,” “PEG #400,” “PEG #600,” “PEG #1000,” “PEG #1500,” “PEG #2000,” “PEG #4000,” “Uniol D-200,” “Uniol D-700,” “Uniol D-1000,” “Uniol D-1200,” “Uniol D-2000,” “Uniol D-4000,” “Uniol PB-500,” “Uniol PB-700,” “Uniol PB-1000,” “Uniol PB-2000,” “Polycerin DC-1100,” “Polycerin DC-1800E,” “Polycerin DC-3000E,” “Polycerin DCB-1000,” “Polycerin DCB-2000,” and “Polycerin DCB-4000” (all are commercially available from NOF Corporation).

Examples of components (a2-2) include aliphatic diisocyanates such as methylene diisocyanate, isopropylene diisocyanate, butane-1,4-diisocyanate, hexamethylene diisocyanate, 2,2,4-trimethylhexamethylene diisocyanate, 2,4,4-trimethylhexamethylene diisocyanate, and a dimer diisocyanate in which a carboxyl group of a dimer acid is replaced with an isocyanate group;

alicyclic diisocyanates such as cyclohexane-1,4-diisocyanate, isophorone diisocyanate, dicyclohexylmethane-4,4′-diisocyanate, 1,3-di(isocyanate methyl)cyclohexane, and methylcyclohexane diisocyanate;
aromatic diisocyanates such as 4,4′-diphenylmethane diisocyanate, 4,4′-diphenyldimethylmethane diisocyanate, 4,4′-diphenyltetramethylmethane diisocyanate, 1,4-phenylene diisocyanate, tolylene diisocyanate, xylylene diisocyanate, m-tetramethyl xylylene diisocyanate, 1,5-naphthalene diisocyanate, 4,4′-dibenzyl diisocyanate, and 1,3-phenylene diisocyanate; and
amino acid diisocyanates such as lysine diisocyanate. These may be used alone or two or more thereof may be used in combination. In addition, regarding the resin (A2), these isocyanurate components, adduct components or biuret components may be used.

The ratio of the component (a2-1) and the component (a2-2) used is usually a ratio (NCO₍ₐ₂₋₂₎/OH₍ₐ₂₋₁₎) of the number of moles (NCO of the isocyanate group of the component (a2-2) and the number of moles (OH₍ₐ₂₋₁₎) of the hydroxy group of the component (a2-1) is preferably about 1.1/1 to 8/1.

The component (a2-3) is a chain extender.

Examples of components (a2-3) include diamines such as ethylenediamine, propylenediamine, hexamethylenediamine, isophorone diamine, dimer diamine, dicyclohexylmethane-4,4′-diamine, 2-hydroxyethyl ethylenediamine, 2-hydroxyethyl propylenediamine, di-2-hydroxyethylethylenediamine, di-2-hydroxyethylpropylenediamine, 2-hydroxypropyl ethylenediamine, and di-2-hydroxypropyl ethylenediamine;

triamines such as diethylenetriamine, dipropylenetriamine, and diethylenetriamine;
tetramines such astriethylenetetramine and tripropylene tetramine;
N-alkyldialkanolamines such as N-methyldiethanolamine, N-ethyldiethanolamine, N-propyldiethanolamine, N-isopropyldiethanolamine, N-butyldiethanolamine, N-isobutyldiethanolamine, N-oleyldiethanolamine, N-stearyldiethanolamine, N-methyldiisopropanolamine, N-ethyldiisopropanolamine, N-propyldiisopropanolamine, and N-butyldiisopropanolamine;
hydrazine or its hydrazine derivatives (adipic acid hydrazine, etc.);
dialkanol alkanoic acids such as glyceric acid, dioxymaleic acid, dioxyfumaric acid, dimethylol acetic acid, dimethylol propionic acid, dimethylol butanoic acid, dimethylol pentanoic acid, and dimethylol caproic acid; and
aromatic hydroxycarboxylic acids such as 4,4-di(hydroxyphenyl)butanoic acid, 4,4-di(hydroxyphenyl)pentanoic acid, and 2,6-dioxybenzoic acid. These may be used alone or two or more thereof may be used in combination. Among these, a dialkanol alkanoic acid is preferable because the produced polymer is easily dissolved or dispersed in water.

Here, a quaternizing salt may be used as the dialkanolamine. The quaternizing salt is a component obtained by reacting the dialkanolamine with a quaternizing agent, and examples of quaternizing agents include inorganic acids such as hydrochloric acid, sulfuric acid, and phosphoric acid; organic acids such as dimethyl sulfate, acetic acid, and propionic acid; and organic halogen compounds such as methyl chloride, benzyl chloride, and epichlorohydrin.

In addition, carboxyl groups of the dialkanol alkanoic acid and the aromatic hydroxycarboxylic acid may be neutralized with a neutralizing agent.

Examples of neutralizing agents include alkali metal hydroxides such as sodium hydroxide and potassium hydroxide; ammonia; and organic amines such as trimethylamine, triethylamine, triethanolamine, triisopropanolamine, N,N-dimethylethanolamine, and N,N-diethylethanolamine. These may be used alone or two or more thereof may be used in combination.

The amount of the component (a2-3) used with respect to 100 weight % of reaction components constituting the resin (A2) is usually 1 to 30 weight % and preferably 3 to 20 weight %.

The resin (A2) of the disclosure may contain a hydroxy alkyl (meth)acrylic acid ester (a2-4) (hereinafter referred to as a component (a2-4)) as a reaction component.

Examples of components (a2-4) include 2-hydroxyethyl (meth)acrylate, 2-hydroxy n-propyl (meth)acrylate, 3-hydroxy n-propyl (meth)acrylate, 3-hydroxy n-butyl (meth)acrylate, 4-hydroxy n-butyl (meth)acrylate, and 6-hydroxy n-hexyl (meth)acrylate. These may be used alone or two or more thereof may be used in combination.

The amount of the component (a2-4) used with respect to 100 weight % of reaction components constituting the resin (A2) is usually 10 weight % or less and preferably 5 weight % or less.

When the component (a2-4) is used, further, a (meth)acrylic acid monoalkyl ester having no hydroxyl group (a2-5) (hereinafter referred to as a component (a2-5)) may be additionally reacted.

Examples of components (a2-5) include methyl (meth)acrylate, ethyl (meth)acrylate, n-propyl (meth)acrylate, isopropyl (meth)acrylate, n-butyl (meth)acrylate, isobutyl (meth)acrylate, s-butyl (meth)acrylate, t-butyl (meth)acrylate, n-pentyl (meth)acrylate, n-hexyl (meth)acrylate, 2-ethylhexyl (meth)acrylate, n-octyl (meth)acrylate, isooctyl (meth)acrylate, n-decyl (meth)acrylate, isodecyl (meth)acrylate, lauryl (meth)acrylate, myristyl (meth)acrylate, isomyristyl (meth)acrylate, palmityl (meth)acrylate, stearyl (meth)acrylate, and isostearyl (meth)acrylate. These may be used alone or two or more thereof may be used in combination.

The amount of the component (a2-5) used with respect to 100 weight % of reaction components constituting the resin (A2) is usually 50 weight % or less and preferably 30 weight % or less.

The reaction component may further contain a chain extension inhibitor (a2-6) (hereinafter referred to as a component (a2-6)). Examples of components (a2-6) include monoalcohols such as methanol, ethanol, n-propyl alcohol, isopropyl alcohol, n-butyl alcohol, and isobutyl alcohol; monoamines such as ethylamine, n-propylamine, diethylamine, di n-propylamine, and di n-butylamine; and alkanol monoamines such as monoethanolamine and diethanolamine. These may be used alone or two or more thereof may be used in combination.

The amount of the component (a2-6) used with respect to 100 weight % of reaction components constituting the resin (A2) is usually 5 weight % or less and preferably 3 weight % or less.

The resin (A2) is obtained by, for example, reacting the component (a2-1) and the component (a2-2) to produce a urethane prepolymer and then reacting the urethane prepolymer and the component (a2-3), and as necessary, the components (a2-4) to (a2-6).

Regarding the reaction conditions in the process of obtaining a urethane prepolymer, the temperature is usually about 40 to 150° C. and preferably about 60 to 100° C. In addition, the time is usually about 1 to 20 hours and preferably about 1 to 10 hours.

Next, regarding the conditions when the urethane prepolymer is reacted with the component (a2-3), and as necessary, the components (a2-4) to (a2-6), the temperature is usually about 20 to 100° C. and preferably about 30 to 80° C. In addition, the time is usually about 1 to 10 hours and preferably about 1 to 5 hours. Here, the mixing method and mixing order of respective components are not particularly limited.

These resins (A2) may be produced in the absence of a solvent or in the presence of a solvent.

Examples of solvents include aromatic hydrocarbons such as benzene, toluene, ethylbenzene, n-propylbenzene, t-butylbenzene, o-xylene, m-xylene, p-xylene, tetralin, decalin, and aromatic naphtha; aliphatic hydrocarbons such as n-hexane, n-heptane, n-octane, isooctane, and n-decane; alicyclic hydrocarbons such as cyclohexane; esters such as ethyl acetate, n-butyl acetate, n-amyl acetate, 2-hydroxyethyl acetate, 2-butoxyethyl acetate, 3-methoxybutyl acetate, and methyl benzoate; ketones such as acetone, methyl ethyl ketone, methyl isobutyl ketone, isophorone, cyclohexanone, and methylcyclohexanone; glycol ethers such as ethylene glycol monomethyl ether, ethylene glycol monoethyl ether, ethylene glycol monobutyl ether, diethylene glycol monomethyl ether, diethylene glycol monoethyl ether, and diethylene glycol monobutyl ether; alcohols such as methanol, ethanol, n-propanol, isopropanol, n-butanol, isobutanol, s-butanol, and t-butanol; amides such as N,N-dimethylformamide and N,N-dimethylacetamide; amines such as N-methylpyrrolidone; water such as deionized water, purified water, tap water, soft water, hard water, and industrial water; and dimethyl sulfoxide. These may be used alone or two or more thereof may be used in combination. In addition, after the reaction is completed, the solvent may be distilled off under a reduced pressure or the like.

The amount of the solvent used is preferably adjusted so that the reaction concentration is 10 weight % or more.

In addition, in the above reaction, the component (B) to be described below may be added.

The resin (A2) may further contain a pigment, a water retention agent, an antifoaming agent, a preservative, a leveling agent, a colorant, an anti-blocking agent, an antioxidant, a UV absorber, a thickener, a dispersant, and a filler.

The weight-average molecular weight of the obtained resin (A2) is 5000 to 500000. Here, the weight-average molecular weight is a value measured by a gel permeation chromatography method (GPC method) using polystyrene as a standard substance.

In addition, the viscosity of the solution of the resin (A2) having a non-volatile content concentration of 35 weight % at a temperature of 25° C. is usually 5 to 20,000 mPa·s and preferably 10 to 10,000 mPa·s. Here, “viscosity” is a value measured by a B-type viscometer.

The component (B) is a paraffin wax, and is a component that imparts excellent oil resistance to a water-based oil resistant agent.

A paraffin wax is obtained by distilling crude oil under a reduced pressure and separating and purifying hydrocarbons with good crystallinity from the obtained distillate, and is mainly composed of linear hydrocarbon (normal paraffin).

Regarding the physical properties of the component (B), for example, the melting point is preferably 45 to 80° C. and more preferably 55 to 80° C.

In the disclosure, the component (B) that has been made into an aqueous emulsion using a dispersant is preferably used. Examples of dispersants include nonionic surfactants, cationic surfactants, anionic surfactants and the like described in Japanese Patent Laid-Open No. 2013-237941.

Commercially available solid products of the component (B) include, for example, “paraffin 115,” “paraffin 120,” “paraffin 125, “paraffin 130,” “paraffin 135,” “paraffin 140,” “paraffin 145,” “paraffin 150,” “paraffin 155,” and “HNP-51” (all are commercially available from Nippon Seiro Co., Ltd.). In addition, examples of aqueous emulsions include “Sizepine W-116H” (commercially available from Arakawa Chemical Industries, Ltd.). These may be used alone or two or more thereof may be used in combination.

The content ratio between the component (A) and the component (B) in terms of the non-volatile content weight is preferably (A)/(B)=10/90 to 90/10 and more preferably (A)/(B)=20/80 to 80/20 because a water-based oil resistant agent exhibits excellent oil resistance.

The water-based oil resistant agent of the disclosure is obtained by mixing the component (A) and the component (B), and as necessary, water. Regarding the mixing conditions, for example, the temperature is 10 to 90° C. (preferably 20 to 80° C.). In addition, the mixing order, mixing method, and mixing time of respective components are not particularly limited.

The water-based oil resistant agent of the disclosure may further contain additives such as a pigment, a water retention agent, an antifoaming agent, an antioxidant, a preservative, a leveling agent, and a colorant.

Regarding the physical properties of the obtained water-based oil resistant agent, the non-volatile content concentration is usually 5 to 50 weight % and preferably 10 to 40 weight %.

In addition, the viscosity of the solution of the water-based oil resistant agent having a non-volatile content concentration of 10 weight % at a temperature of 25° C. is usually 5 to 100 mPa·s and preferably 10 to 80 mPa·s.

The oil resistant paper of the disclosure is obtained by applying the water-based oil resistant agent to base paper.

Examples of base paper include those made from chemical pulps such as leaf bleached kraft pulp (LBKP) and needle bleached kraft pulp (NBKP); mechanical pulps such as ground pulp (GP), refiner ground pulp (RGP), and thermomechanical pulp (TMP); DIP, mercerized pulp, recycled pulp and the like by various paper machines, and more specific examples thereof include bleached kraft paper, unbleached kraft paper, woodfree paper, medium quality paper, finely coated paper, coated paper, processed base paper, paperboard, white paperboard, liner, semi-glassine paper, glassine paper, and parchment paper. In addition, the pulp containing pH adjusting agents such as aluminum sulfate, sulfuric acid and sodium hydroxide; papermaking chemicals such as a sizing agent, paper strengthening agents (for example, starch and polyacrylamide), and a wet paper strengthening agent; and fillers such as talc, clay, kaolin, titanium dioxide, and calcium carbonate may be used.

Examples of a method of applying a water-based oil resistant agent include methods using a bar coater, a knife coater, a size press coater, a roll coater, a reverse roll coater, a curtain coater, a gravure coater, an air knife coater, a calender, a gate roll coater, a blade coater, a 2-roll size press, rod metering and the like. In addition, the coating amount of the coating liquid (in terms of the non-volatile content) is not particularly limited, and is usually about 0.1 to 10 g/m² and preferably about 1 to 6 g/m².

The base paper after application is dried by heat. Examples of heat sources include a hot air dryer, an infrared heater, and a rotary dryer. In addition, regarding the drying conditions, for example, the temperature is 80 to 180° C. (preferably 100 to 150° C.) and the time is 0.1 to 180 minutes (preferably 0.5 to 60 minutes).

### EXAMPLES

Hereinafter, the disclosure will be described with reference to examples, but the disclosure is not limited thereto. Unless otherwise specified, “parts” and “%” in examples and comparative examples are based on weight.

### Production Example 1

98 parts of maleic anhydride and 75.2 parts of toluene were put into a reaction container including a stirrer, a reflux cooling pipe, a nitrogen introduction pipe and two dropping funnels while introducing nitrogen, and the reaction system was heated to 110° C. while stirring under a nitrogen gas stream. Then, 73.7 parts of diisobutylene (76% content of 2,2,4-trimethyl-1-pentene), 112 parts of 1-hexadecene, and 12 parts of n-butyl acrylate were put into the dropping funnel (1) and 6.6 parts of t-butylperoxybenzoate, and 35 parts of toluene were put into the dropping funnel (2), and these were added dropwise into the container over 1.5 hours. After being kept warm for 2 hours under reflux, 2.6 parts of t-butylperoxybenzoate and 15 parts of toluene were added dropwise over 30 minutes, and additionally, the mixture was kept warm at the same temperature for 1 hour. 16 parts of sodium hydroxide, 85 parts of 28% ammonia water and a predetermined amount of water were added and stirred, toluene was distilled off under a reduced pressure, and an olefin resin (A1-1) having a non-volatile content concentration of 20%, a viscosity of 80 mPa·s, and a pH of 9.0 was obtained.

### Production Example 2

While introducing nitrogen into the same reaction container as in Production Example 1, 98 parts of maleic acid and 75.2 parts of toluene were put thereinto, and the reaction system was heated to 110° C. while stirring under a nitrogen gas stream. Then, 197.7 parts of diisobutylene (76% content of 2,2,4-trimethyl-1-pentene) was put into the dropping funnel (1) and 6.6 parts of t-butylperoxybenzoate and 35 parts of toluene were put into the dropping funnel (2), and these were added dropwise into the container over 1.5 hours. After being kept warm for 2 hours under reflux, 2.6 parts of t-butylperoxybenzoate and 15 parts of toluene were added dropwise over 30 minutes, and additionally, the mixture was kept warm at the same temperature for 1 hour. 16 parts of sodium hydroxide, 85 parts of 28% ammonia water and a predetermined amount of water were added and stirred, toluene was distilled off under a reduced pressure, and an olefin resin (A1-2) having a non-volatile content concentration of 20%, a viscosity of 100 mPa·s, and a pH of 9.0 was obtained.

### Production Example 3

59.4 parts of dimethylol butanoic acid, 489.9 parts of Polycerin DCB-2000 (polyoxytetramethylene-polyoxypropylene glycol, a number-average molecular weight of 2,000, commercially available from NOF Corporation), and 200.8 parts of isophorone diisocyanate were put into a reaction container including a stirrer, a thermometer, a cooling pipe and a nitrogen gas introduction pipe, and reacted at 85° C. for 5 hours under a nitrogen gas stream, and 750 parts of a urethane prepolymer was obtained. Then, the urethane prepolymer was added to an aqueous solution containing 1,208 parts of water, 225 parts of isopropyl alcohol, 40.5 parts of triethylamine, and 43.3 parts of adipic acid dihydrazide, and dispersed under stirring. The mixture was reacted at 50° C. for 3 hours, a predetermined amount of water was additionally added, and a urethane resin (A2-1) having a non-volatile content concentration of 35%, a viscosity of 800 mPa·s/25° C., and a pH of 8.0 was obtained.

### Production Example 4

59.4 parts of dimethylol butanoic acid, 489.9 parts of PTMG1000 (polytetramethylene glycol, a number-average molecular weight of 1,000, commercially available from Mitsubishi Chemical Corporation), and 275.5 parts of isophorone diisocyanate were put into a reaction container including a stirrer, a thermometer, a cooling pipe and a nitrogen gas introduction pipe, and reacted at 85° C. for 5 hours under a nitrogen gas stream, and 824 parts of a urethane prepolymer was obtained. Then, the urethane prepolymer was added to and dispersed in an aqueous solution containing 1340 parts of water, 225 parts of isopropyl alcohol, 40.5 parts of triethylamine, and 43.3 parts of adipic acid dihydrazide under stirring. The mixture was reacted at 50° C. for 3 hours reaction, a predetermined amount of water was additionally added, and a urethane resin (A2-2) having a non-volatile content concentration of 35%, a viscosity of 800 mPa·s, and a pH of 8.0 was obtained.

### Example 1

250.0 parts of the olefin resin (A1-1) (non-volatile content of 50 parts), 166.7 parts (non-volatile content of 50 parts) of a paraffin wax (product name: “Sizepine W-116H,” commercially available from Arakawa Chemical Industries, Ltd.) and 583.3 parts of deionized water were mixed to obtain a water-based oil resistant agent.

### Examples 2 to 7 and Comparative Examples 1 to 9

Water-based oil resistant agents were obtained in the same manner as in Example 1 except that the compositions and contents were changed as shown in Table 1.

(Production of Oil Resistant Paper)

A water-based oil resistant agent was applied to commercially available processed base paper (a basis weight of 50 g/m², a Stockigt size degree of 12 seconds, and an air impermeability of 80 seconds) with a wire bar of any count and then dried with hot air dryer set at 120° C. for 5 minutes to obtain oil resistant paper.

(Oil Resistance)

The coated surface was measured by a JAPAN TAPPI paper pulp test method No. 41: 2000 (kit method). The oil resistant paper having a kit oil resistance of grade 4 or higher was preferably used, and the coating amount of the water-based oil resistant agent when that value was exhibited was preferably 5 g/m² or less.

(Air Permeability)

The air impermeability was measured by JIS P8117. For the oil resistant paper having high air permeability, 1,000 seconds or less is preferable.

TABLE 1

| | | | | | Wax | | Coating | | Air |
|---|---|---|---|---|---|---|---|---|---|
| | Resin | | | | (parts by | | amount | Oil | impermeability |
| | (parts by weight^{※1}) | | | | weight^{※1}) | | (g/m²) | resistance | (seconds) |
| Example 1 | A1-1 | 50 | — | | B-1 | 50 | 2.2 | 5 | 390 |
| Example 2 | A1-2 | 50 | — | | B-1 | 50 | 3.6 | 4 | 670 |
| Example 3 | A2-1 | 50 | — | | B-1 | 50 | 2.0 | 4 | 260 |
| Example 4 | A2-2 | 50 | — | | B-1 | 50 | 1.6 | 4 | 260 |
| Example 5 | A1-1 | 75 | — | | B-1 | 25 | 2.8 | 4 | 690 |
| Example 6 | A1-1 | 25 | — | | B-1 | 75 | 2.0 | 4 | 220 |
| Example 7 | A1-1 | 25 | A2-2 | 25 | B-1 | 50 | 2.0 | 5 | 900 |

| Comparative | A1-1 | 100 | — | — | | 8.6 | 3 | 7050 |
|---|---|---|---|---|---|---|---|---|
| Example 1 | | | | | | | | |
| Comparative | A2-1 | 100 | — | — | | 2.0 | 1 | 2870 |
| Example 2 | | | | | | | | |
| Comparative | — | | — | B-1 | 100 | 8.1 | 5 | 11700 |
| Example 3 | | | | | | | | |
| Comparative | C-1 | 50 | — | B-1 | 50 | 3.6 | 3 | 2660 |
| Example 4 | | | | | | | | |
| Comparative | C-2 | 50 | — | B-1 | 50 | 3.8 | 2 | 480 |
| Example 5 | | | | | | | | |
| Comparative | C-3 | 50 | — | B-1 | 50 | 2.0 | 4 | 24900 |
| Example 6 | | | | | | | | |
| Comparative | A1-1 | 50 | — | D-1 | 50 | 3.6 | 1 | 6690 |
| Example 7 | | | | | | | | |
| Comparative | A1-1 | 50 | — | D-2 | 50 | 3.2 | 3 | 5500 |
| Example 8 | | | | | | | | |
| Comparative | A1-1 | 50 | — | D-3 | 50 | 3.8 | 0 | 6510 |
| Example 9 | | | | | | | | |

^{※1}The parts by weight of each component are expressed by the weight of the non-volatile content.

The symbols in Table 1 indicate the following compounds.

### (Resins)

A1-1: olefin resin of Production Example 1

A1-2: olefin resin of Production Example 2

A2-1: urethane resin of Production Example 3

A2-2: urethane resin of Production Example 4

C-1: olefin resin having 2 carbon atoms (product name: “Chemipearl S100,” commercially available from Mitsui Chemicals, Inc.)

C-2: styrene resin (product name: “Polymaron 1383,” commercially available from Arakawa Chemical Industries, Ltd.)

C-3: polyvinyl alcohol (product name: “Kuraray Poval 11-98,” commercially available from Kuraray Co., Ltd.)

### (Wax)

B-1: paraffin wax (product name: “Sizepine W-116H,” commercially available from Arakawa Chemical Industries, Ltd.)

D-1: polyethylene wax (product name: “Chemipearl W401,” commercially available from Mitsui Chemicals, Inc.)

D-2: AKD emulsion (product name: “Sizepine K-924,” commercially available from Arakawa Chemical Industries, Ltd.)

D-3: fatty acid emulsion (product name: “Sizepine CA-956,” commercially available from Arakawa Chemical Industries, Ltd.)

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A water-based oil resistant agent containing at least one resin (A) selected from the group consisting of the following (A1) and (A2), and paraffin wax (B):
(A1) an olefin resin which is a polymer containing monoolefins having a total number of carbon atoms of 4 or more (a1-1) and an α,β-unsaturated carboxylic acid (a1-2) as essential reaction components; and
(A2) a urethane resin which is a polymer containing a polyol (a2-1), a polyisocyanate (a2-2) and a chain extender (a2-3) as essential reaction components.

2. The water-based oil resistant agent according to claim 1,
wherein the components (a1-1) are a monoolefin having a total number of carbon atoms of 4 to 10 (I) and a monoolefin having a total number of carbon atoms of 12 to 20 (II).

3. The water-based oil resistant agent according to claim 1,
wherein the reaction components constituting the resin (A1) further contain an α,β-unsaturated monocarboxylic acid alkyl ester (a1-3).

4. The water-based oil resistant agent according to claim 1,
wherein the component (a2-3) contains a dialkanol alkanoic acid.

5. The water-based oil resistant agent according to claim 1,
wherein a content ratio between the component (A) and the component (B) in terms of the non-volatile content weight is (A)/(B)=10/90 to 90/10.

6. Oil resistant paper obtained by applying the water-based oil resistant agent according to claim 1 to base paper.
